(19) United States
(12) Patent Application Publication
(10) Pub. No.: US 2004/0201704 A1
(43) Pub. Date: Oct. 14, 2004

(54) Vibration compensation device and scanning method

(76) Inventors: Jen-Shou Tseng, Miao-Li Hsien (TW); Cheng-Kuei Chen, Hsinchu (TW)

Correspondence Address: J.C. Patents, Inc., 4 VENUTE, SUITE 250, Irvine, CA, 92618, US

(21) Appl. No.: 09/922,252

(22) Filed: Aug. 3, 2001

(51) Int. Cl. H04N 5/228

(52) U.S. Cl. 348/208.1

(57) ABSTRACT

A vibration compensation device for an optical image scanner. The optical scanner has a platform for holding a scan document, an optical system and a light-sensing device. The compensation device includes a vibration sensor, a controller and an actuator. The vibration sensor mounts on the light-sensing device for detecting magnitude of vibration. The controller connects with the vibration sensor for measuring vibration in the light-sensing device and producing a corresponding actuator signal. The actuator links independently with the controller and the optical system for adjusting the optical system through the actuator according to the actuator signal so that the overall effects caused by vibration are reduced.

### BACKGROUND OF THE INVENTION

1. Field of Invention

The present invention relates to a compensation device inside an optical image scanner. More particularly, the present invention relates to a compensation device capable of compensating optical path deviation inside a scanner due to vibration.

2. Description of Related Art

Due to an increase in utilization and breakthrough in related photo-sensing techniques, the resolution of a scanner has gradually increased from 200 dpi (dot per inch) in the black and white or the gray scale to 300 dpi, 600 dpi, 1000 dpi, 2000 dpi and even 4000 dpi in the color scale. As resolution of a scanner is increased, scanning is increasingly sensitive to any vibration inside the scanner.

Most optical scanner operates by projecting light from a light source onto a scan document. Light reflecting from the scan document is channeled to a set of flat mirrors and eventually projected onto a charge-coupled device (CCD). Optical signal received by the CCD is converted into digital data and transferred to a storage device. When a transparent lens together with the CCD inside the scanner is driven by a transmission mechanism, some vibration may be produced. Such vibration is likely to affect quality of the scanned image if a suitable measure to compensate the effect of vibration is effected. FIG. 1 is a diagram showing the deviation of optical path inside a conventional scanner due to vibration. To conduct an optical scanning, the transmission system (not shown) of the scanner drives the optical system (the set of flat mirrors 110 and the lens 108) and the light sensing device 104 (such as a charge-coupled device) in a scanning direction. For every short distance traversed by the optical system, the light sensing device 104 scans a bit of the scan document 100 placed on the platform 102. The scanned data is transferred to a storage device (not shown). During a scanning operation, light from a light source (not shown) projects to the scan document 100 and reflects to the set of flat mirrors 110. Light reflected by the set of flat mirrors 110 travels through the lens 108 to arrive at the sensing device 104. In general, the transmission system may produce some vibration during a scanning operation. Hence, the entire optical system may oscillate leading to optical path deviation \overline{N′N} and abnormal image color. Ultimately, quality of the resulting scan image will degrade. Such optical system vibration and optical path deviation \overline{N′N} due to vibration happens in all three spatial dimensions, that is, the x-axis, the y-axis and the z-axis. In FIG. 1, only optical system vibration in the z-direction and corresponding optical deviation \overline{N′N} in the y-direction is shown.

### SUMMARY OF THE INVENTION

Accordingly, one object of the present invention is to provide a compensation device inside a scanner for compensating the effect of vibration on an optical system so that quality of scanned image is improved.

To achieve these and other advantages and in accordance with the purpose of the invention, as embodied and broadly described herein, the invention provides a vibration compensation device inside an optical scanner. The optical scanner includes a platform for holding a scan document, an optical system and a light-sensing device. The vibration compensation device includes a vibration sensor, a controller and an actuator. The vibration sensor is mounted on the light-sensing device to detect any vibration of the light-sensing device. The controller is connected to the vibration sensor for measuring magnitude of vibration of the light-sensing device and producing a corresponding actuator signal. The actuator connects with the controller and the optical system for adjusting the optical system according to the actuator signal. Ultimately, the vibration is compensated. This invention also permits the linkup of the actuator and the platform so that the platform can move according to the actuator signal so that any vibration is compensated.

One aspect of this invention is the attachment of a vibration sensor to the light-sensing device so that any vibration of the scan image may be measured. Through connection between the actuator and the optical system, the optical system can be adjusted according to the magnitude of vibration measured by the vibration sensor. Hence, image vibration is compensated.

Another aspect of this invention the provision of a linkage between the actuator and the platform so that the platform may move to compensate for any vibration according to the magnitude of vibration in the scanner.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram showing the deviation of optical path inside a conventional scanner due to vibration;

FIG. 2 is a schematic diagram showing a vibration compensation device inside an optical scanner according to a first preferred embodiment of this invention;

FIG. 3 is a schematic diagram showing a vibration compensation device inside an optical scanner according to a second preferred embodiment of this invention;

FIG. 4 a flow chart showing the steps for compensating vibration effects during a scanning operation according to the first preferred embodiment of this invention; and

FIG. 5 a flow chart showing the steps for compensating vibration effects during a scanning operation according to the second preferred embodiment of this invention.

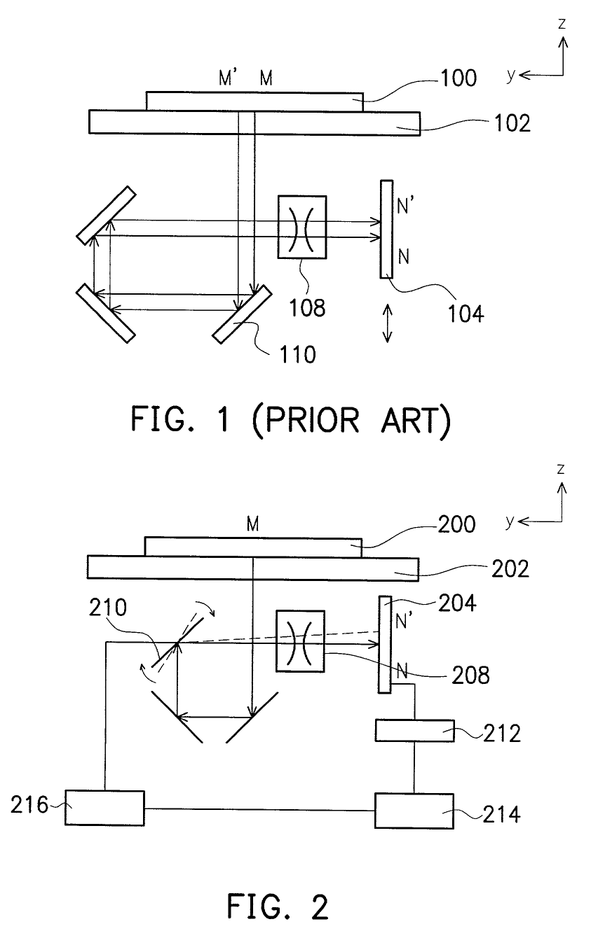

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a schematic diagram showing a vibration compensation device inside an optical scanner according to a first preferred embodiment of this invention. As shown in FIG. 2, the vibration compensation device is installed inside the optical scanner. The optical scanner includes a light source (not shown), a platform 202 for holding a scan document 200, an optical system (including a set of flat mirrors 210 and a lens 208) and a light-sensing device 204.

In general, any transmission system produces some vibrations. Hence, the optical system also vibrates during a scanning operation leading to optical path deviation \overline{N′N}. Although vibration may occur in the x, y and z direction leading to optical path deviation \overline{N′N}, FIG. 2 mainly illustrates the optical deviation in the y-direction to simplify description. Utilizing the vibration compensation device according to this embodiment, optical deviation due to vibration can be minimized.

As shown in FIG. 2, the vibration compensation device includes a vibration sensor 212, a controller 214 and an actuator 216. The vibration sensor 212 is mounted on the light-sensing device 204 of the optical scanner to detect magnitude of vibration (optical path deviation \overline{N′N}) of the light-sensing device 204. The controller 214 and the vibration sensor 212 are connected so that vibration magnitude of the light-sensing device 204 is measured and an actuator signal is produced. The controlling method used by the controller 214 includes, for example, common PID control. The actuator 216 is independently linked to the controller 214 and the optical system (set of flat mirrors 210 and the lens 208). The actuator 216 adjusts the optical system according to the actuator signal so that the effects of vibration can be reduced. The actuator 216 adjusts the optical system, for example, by rotating the flat mirror 210.

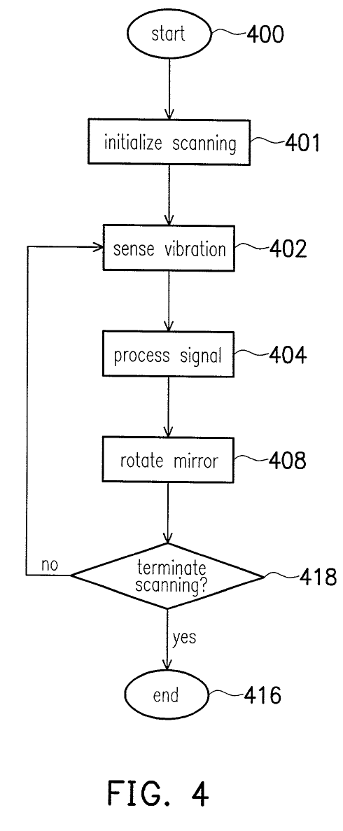

FIG. 4 a flow chart showing the steps for compensating vibration effects during a scanning operation according to the first preferred embodiment of this invention. The method corresponds to the vibration compensation device shown in FIG. 2. After initializing the optical system (step 400), scanning begins (step 401). A vibration sensing step is executed (in step 402) using the vibration sensor 212 to detect magnitude of vibration of the light-sensing device 204. A signal-processing step (step 404) is carried out such that vibration magnitude is converted to an electrical signal by the controller 216. According to the electrical signal, a corresponding actuator signal is produced. The actuator 216 adjusts the optical system according to the actuator signal so that the effects of vibration are minimized. The optical system is adjusted, for example, by rotating one of the flat mirrors 210 (step 408). Thereafter, a scanning termination inquiry is conducted (step 418). If scanning is finished, the process ends (in step 416). Otherwise, the process is repeated starting from the vibration-sensing step (step 402) again.

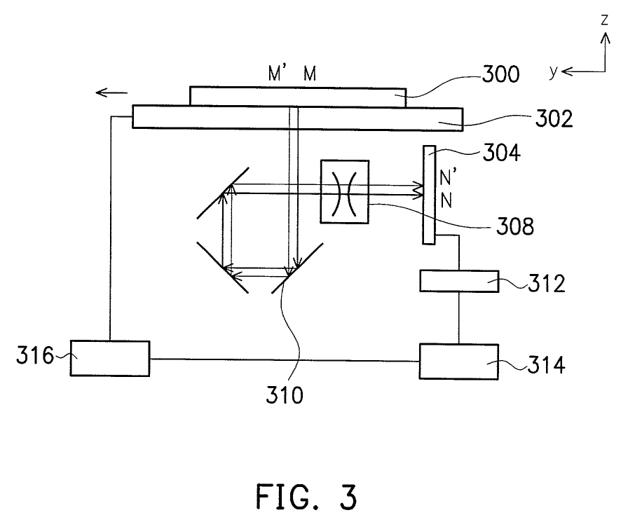

FIG. 3 is a schematic diagram showing a vibration compensation device inside an optical scanner according to a second preferred embodiment of this invention. As shown in FIG. 3, the vibration compensation device is installed inside the optical scanner. The optical scanner includes a light source (not shown), a platform 302 for holding a scan document 300, an optical system (including a set of flat mirrors 310 and a lens 308) and a light-sensing device 304.

Although vibration may occur in the x, y and z direction leading to optical path deviation \overline{N′N}, FIG. 3 mainly illustrates the optical deviation in the y-direction to simplify description. Utilizing the vibration compensation device according to this embodiment, optical deviation due to vibration can be minimized.

As shown in FIG. 3, the vibration compensation device includes a vibration sensor 312, a controller 314 and an actuator 316. The vibration sensor 312 is mounted on the light-sensing device 304 of the optical scanner to detect magnitude of vibration (optical path deviation \overline{N′N}) of the light-sensing device 304. The controller 314 and the vibration sensor 312 are connected so that vibration magnitude of the light-sensing device 304 is measured and a corresponding actuator signal is produced. The controlling method used by the controller 314 includes, for example, common PID control. The actuator 316 is independently linked to the controller 314 and the platform 302 of the optical scanner. The actuator 316 adjusts the platform 302 according to the actuator signal so that the effects of vibration can be reduced.

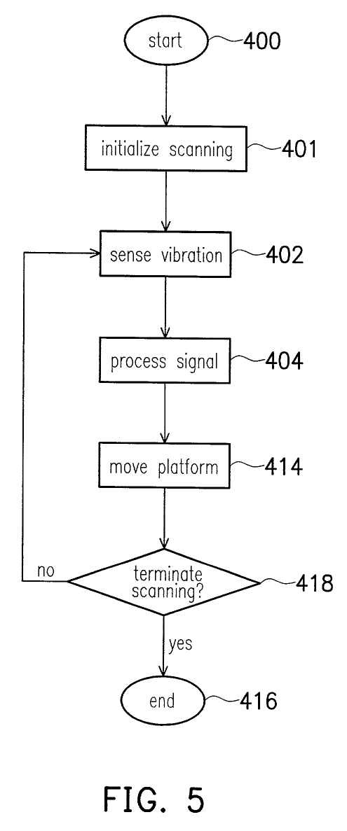

FIG. 5 a flow chart showing the steps for compensating vibration effects during a scanning operation according to the second preferred embodiment of this invention. The method corresponds to the vibration compensation device shown in FIG. 3. The method is very similar to the one shown in FIG. 4. Hence, detailed description of each step is omitted. One major difference between the second and the first embodiment is that the platform (step 414 in FIG. 5) moves instead of the optical system (such as rotating one of the flat mirrors 210 in step 408 of FIG. 4).

In summary, major advantages of this invention include the following:

1. The vibration compensation device uses a vibration sensor on the light-sensing device to measure any vibration of the scan image. Together with a controller and an actuator, effects caused by vibration in the optical scanner are very much reduced.

2. By connecting the actuator to the optical system of the scanner and adjusting the optical system through the actuator, effects on the scan image due to vibration are reduced.

3. Similarly, by connecting the actuator to the platform of the scanner and moving the platform, effects on the scan image due to vibration are reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A vibration compensation device for an optical scanner having a platform for holding a scan document, an optical system and a light-sensing device, the vibration compensation device comprising:
a vibration sensor mounted on the light-sensing device of the optical scanner for detecting magnitude of vibration of the light-sensing device;
a controller connected to the vibration sensor for measuring the magnitude of vibration of the light-sensing device and producing a corresponding actuator signal; and
an actuator independently connected to the controller and the optical system of the scanner for adjusting the optical system according to the actuator signal such that overall effects due to vibration are minimized.

2. The vibration compensation device of claim 1, wherein the optical system further includes a set of flat mirrors and method of adjusting the optical system through the actuator includes rotating one of the flat mirrors.

3. A vibration compensation device for an optical scanner having a platform for holding a scan document, an optical system and a light-sensing device, the vibration compensation device comprising:
a vibration sensor mounted on the light-sensing device of the optical scanner for detecting magnitude of vibration of the light-sensing device;
a controller connected to the vibration sensor for measuring the magnitude of vibration of the light-sensing device and producing a corresponding actuator signal; and
an actuator independently connected to the controller and the platform of the scanner for moving the platform according to the actuator signal such that overall effects due to vibration are minimized.

4. A method of compensating the vibration inside an optical scanner having a platform for holding a scan document, an optical system and a light-sensing device, the method comprising:
measuring the magnitude of vibration of the light-sensing device;
converting the measured vibration magnitude into an electrical signal so that an actuator signal corresponding to the electrical signal is produced; and
compensating the vibration by adjusting the optical system according to the actuator signal.

5. The method of claim 4, wherein the optical system further includes a set of flat mirrors and the method of adjusting the optical system through the actuator includes rotating one of the flat mirrors.

6. A method of compensating the vibration inside an optical scanner having a platform for holding a scan document, an optical system and a light-sensing device, the method comprising:
measuring the magnitude of vibration of the light-sensing device;
converting the measured vibration magnitude into an electrical signal so that an actuator signal corresponding to the electrical signal is produced; and
compensating the vibration by moving the platform according to the actuator signal.
